(19) United States
(12) Patent Application Publication
(10) Pub. No.: US 2008/0023573 A1
(43) Pub. Date: Jan. 31, 2008

(54) LIQUID SPREADER PRIMARILY FOR DE-ICING

(75) Inventors: Michael P. Ossian, DeWitt, IA (US); Kenneth C. Ossian, Bettendorf, IA (US)

Correspondence Address: MCKEE, VOORHEES & SEASE, P.L.C., 801 GRAND AVENUE, SUITE 3200, DES MOINES, IA, 50309-2721, US

(73) Assignee: OSSIAN, INC., DAVENPORT, IA (US)

(21) Appl. No.: 11/828,881

(22) Filed: Jul. 26, 2007

Related U.S. Application Data
(60) Provisional application No. 60/820,530, filed on Jul. 27, 2006.

(51) Int. Cl. B05B 1/20

(52) U.S. Cl. 239/168; 239/170; 239/722

(57) ABSTRACT

A liquid de-icer applicator which is specifically designed for convenient de-icer application, as opposed to simple agricultural spray. The unit has a horizontal frame chassis with an attached push handle, a tank detachably mounted on the chassis for holding and dispensing liquid de-icer, a pair of foldable wing spray bars mounted to the front of the chassis which can move from folded or closed transport position to operational positions. The foldable wing spray bars are fluidly connected to a spray system which can be selectively operated at the spray bars or by use of a wand. The applicator has a pair of spaced apart wheels mounted near the rear end of the chassis, behind and below the tank in order to allow convenient and balanced mobility. Finally, there is an associated power supply (battery) for operation of the spray system and it is all housed under a protective housing. Preferably the unit includes a control panel mounted on the push handle.

### CROSS-REFERENCE TO RELATED APPLICATIONS

This application claims the benefit of the filing date of earlier filed provisional application Ser. No. 60/820,530 of Jul. 27, 2006, entitled LIQUID SPREADER FOR DE-ICING SIDEWALKS AND STEPS, and which application is hereby incorporated by reference in its entirety.

### FIELD OF THE INVENTION

The present invention relates to a device for liquid de-icer application, specifically designed for winter use, making it more suitable for use in de-icing as opposed to simply using general use agricultural sprayers.

### BACKGROUND OF THE INVENTION

The use of liquid de-icer compositions is known. Some prefer liquid de-icers over solid form pellets, since liquids have unique melting properties and spread easier than dry products. However, the application process for liquid de-icers can often be difficult for the operator. Currently application methods center around use of heavy manual pump fertilizer sprayers, carried in one hand or carried in a back harness, and applied with a hand wand. These are not satisfactory for winter use for a variety of reasons. The operator needs to stop regularly to repump the sprayer. They also have capacity and weight issues, making this unappealing, particularly in the winter when standing in the cold, on ice. Even further compounding the problem is that liquid de-icer chemicals are heavy, typically running eleven or more pounds per gallon. This makes wand application over long stretches of sidewalk or driveways difficult and tiring.

In order to overcome these deficiencies, there have been some efforts at developing mobile sprayers for de-icing sidewalks and steps that may be pushed like a lawn mower while using battery powered spray systems. People trying this approach have simply turned to lawn and garden sprayers mounted much like an engine is mounted on a hand push lawn mower chassis. However, there are certain design and environmental condition requirements encountered by de-icing spray systems in the wintertime that simply make adaptation of a conventional lawn mower chassis to de-icer spray system using a tank, ill-suited for best de-icer needs.

Among the problems that occur are those resulting from the winter conditions, the weight of the de-icer, and metal corrosion. With the goal of the sprayer to be easily maneuvered on ice and snow covered paved areas for controlled spray patterns, there is a need to address the proper arrangement necessary to achieve this; at the same time there must be some sort of braking system to allow one to let the unit sit motionless while acting as a pump station to power a spray wand use. The operator must be confident that it will not simply roll away on an inclined or icy surface.

Moreover, additional problems are found with the spray bar that is typically used in the front of mobile sprayers, such as agricultural sprayers. It often gets in the way, either because it is not needed for the particular application, or it is needed in a slightly different configuration than a fixed bar, which is typical. There is therefore a need for a collapsible spray boom hinged in two points off the front corners of the de-icer sprayer chassis which may expand or unfold like wings of a folding tool bar. It can then be selectively and independently moved from an operable position to an inoperable position or anywhere in between.

Another problem with conventional agricultural use sprayers using hand wands is an erratic spray pattern, meaning that some areas get skipped. There is a need for a unit that therefore has both adjustable spray booms for uniform application and as optional for the user, a hand wand to get at difficult places not reachable by the booms.

Another difficulty sometimes encountered with a lawn mower-type chassis that has spray booms attached to the front is that the booms themselves can get in the way; they therefore need to be selectively moveable from operational or extended positions to non-operable collapsed, storage positions.

Yet another issue with conventional agricultural sprayers when used for de-icers is that the pump system must be shielded and isolated from the often difficult environmental conditions such as moisture, corrosive effects of de-icer salts, and snow and ice that may cause pump operation difficulties.

Another need is to have a mobile unit which can have an easily removed quick change tank with a push/pull connection and one which has the hose and pumping system, as well as its electrical system all operating under cover, protected from the difficult winter environment.

The solving of the above problems and needs, specific to de-icer application systems, as opposed to using boomed agricultural systems, portable pump sprayers or backpacks can be achieved by use of the system of the present invention. It uses alternately and selectively in combination collapsible wing sprayers, the use of a hand held wand, the use of a chassis brake, environmentally protected power and pump components, and a quick change with a push/pull connection tank. The invention therefore addresses these specific needs and perhaps others, all unique to de-icer spray systems, as opposed to conventional lawn and garden sprayers. It therefore can be seen that the invention solves the stated problems and needs and represents an advance and improvement for the de-icing industry.

### BRIEF SUMMARY OF THE INVENTION

A liquid de-icer applicator which is specifically designed for convenient de-icer application, as opposed to modifying an agricultural spray. The unit has a generally horizontal rigid chassis with an attached push handle, a tank detachably mounted on the chassis for holding and dispensing liquid de-icer, one or more adjustable wing spray bars mounted to the chassis which can move from retracted or closed transport position to various operational positions. Adjustable wing spray bars are fluidly connected to a spray system which can be selectively operated at the spray bars and a set of fixed spray nozzles or by use of a hand wand. The applicator has a pair of spaced apart wheels mounted to allow convenient and balanced mobility. Finally, there is an associated power supply (battery) for operation of the spray system and it is all housed under a protective housing. Preferably the unit includes a control panel mounted on the push handle for control of the spray booms, and the spray itself.

### BRIEF DESCRIPTION OF THE DRAWINGS

FIG. 1 is a perspective view of the de-icer application unit in perspective, with the quick change tank removed.

FIG. 2 is a front view of the de-icer of FIG. 1.

FIG. 3 is a rear view of the de-icer of FIG. 1.

FIG. 4 is a side view of the de-icer, showing the side which holds the selectively usable spray wand.

FIG. 5 is a top view of the de-icer of the present invention, with parts broken away to show the ports below the top cover.

FIG. 6 is a schematic of valving and pump lines showing how the de-icer may be selectively distributed to the fixed front nozzles and those mounted on the spray bars, or to the hand held spray wand.

FIG. 7 is a schematic of the electrical system of the unit.

FIG. 8 shows the inlet plumbing subassembly and battery cover with its integral tube fittings.

FIG. 9 shows the construction of the quick disconnect shown in FIG. 8.

### DETAILED DESCRIPTION OF THE PREFERRED EMBODIMENT

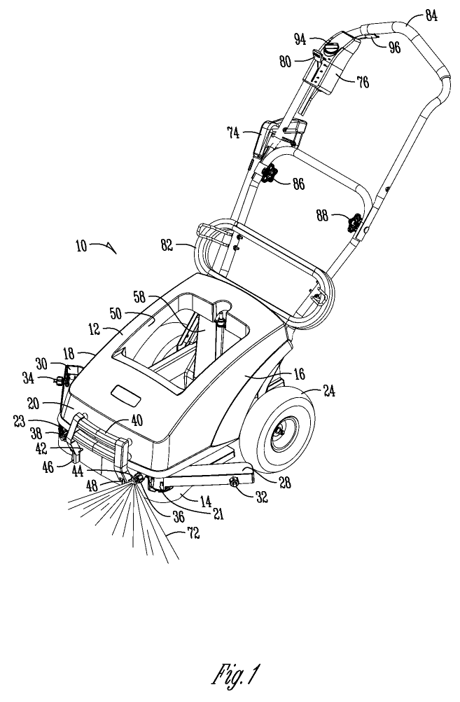

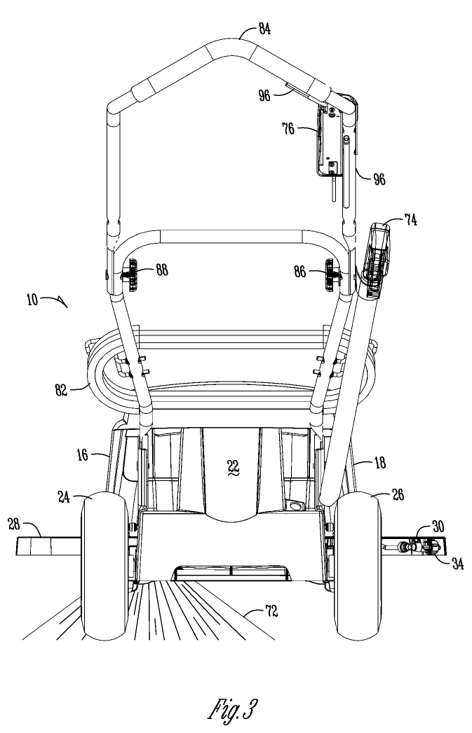

FIGS. 1-8 show a preferred embodiment of the present invention. It is understood that this preferred embodiment is illustrative only and that there are other embodiments that are fully intended to come within the scope of the attached claims. The Applicant therefore intends to rely fully upon the current state of the U.S. Patent Laws as of the time of this filing, including the doctrine of equivalents. It is within the spirit of this understanding that the detailed description is provided. It should also be mentioned that unit may be used to spray liquids other than de-icers, even though it is especially designed for that purpose.

Referring to FIG. 1, there is shown in perspective a de-icer spray apparatus 10 which has a cowling or cover 12 which protects the covered battery, plumbing, circuitry and pump from the exterior weather environment. The de-icer 10 has a rigid chassis 14 having sides 16, 18, and front 20 and rear 22. The chassis 14 is supported by two rear wheels 24, 26 connected adjacent the rear end of the rigid chassis 14.

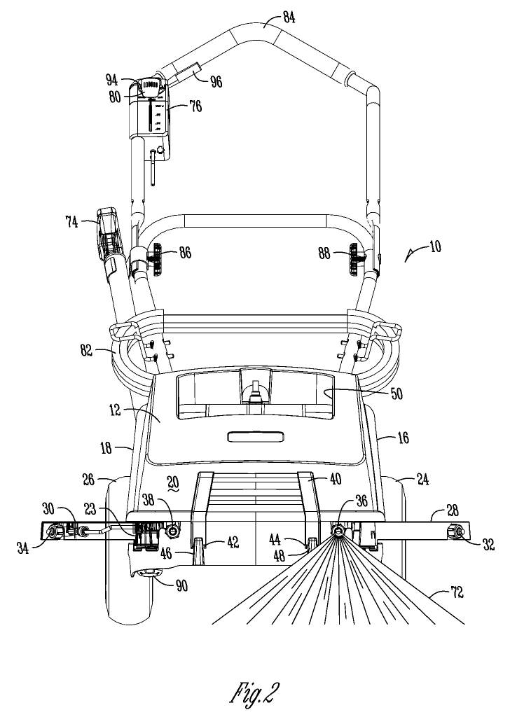

Pivotally mounted hubs at 21 and 23 to the sides 16, 18 of chassis 14 near the front 20 which connect to the side booms or side spray bars 28, 30. Side spray bars 28 and 30 are snap fit mounted to rigid chassis so that they may be selectively moved between various open operable position (FIG. 2) to a closed or retracted positions where they are parallel to, and underneath the chassis sides 16 and 18.

Mounted to each of the spray bars 28 and 30 are spray nozzles 32, 34 and similarly mounted are fixed spray nozzles 36, 38 on front 20 of chassis 14.

Bumper 40 is attached to the front of cowling 12 and pivotally mounted at 42, 44 to posts 46 and 48 attached to the front 20 of chassis 14. It therefore can be seen that cowling 12 can be pivoted up and forward by pivot points 46, 48 to reveal the interior of the device 10.

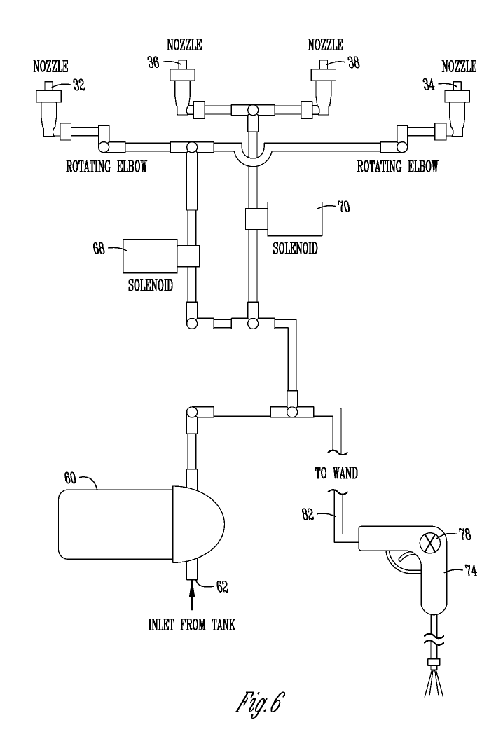

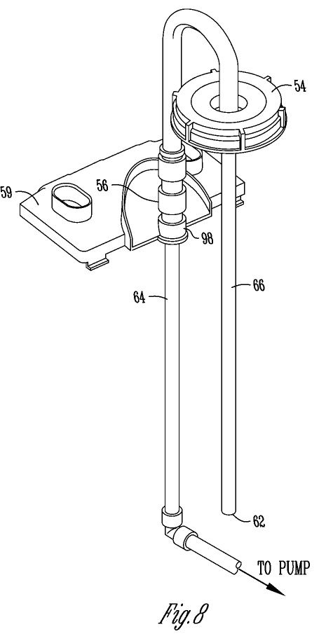

Cowling or housing 12 has a central opening 50 for holding inert plastic (non-corrosive) de-icer tank 52. De-icer tank 52 has a screw on lid 54 (FIG. 8) with a quick hose connection for fluid line to diaphragm pump 60 resting in the forward front portion of compartment of the housing or cowling 12, the bottom of which is defined by chassis 14. Pump 60 pumps de-icer by a pump inlet 62 and feed tube 64, and tank siphon tube 66 to the spray nozzles and wand. Pump 60 action is illustrated with the plumbing circuitry/solenoid valve operation combination in FIG. 6 to demonstrate how fluid is transported to the spray nozzles. FIG. 6 shows how de-icer from tank 52 may be directed selectively (depending on which way solenoid switches 68 and 70 operate) to selectively provide de-icer spray 72 to the boom nozzles 32, 34 and/or front nozzles 36, 38 or alternatively to hand wand 74 via trigger controlled manual valve 78.

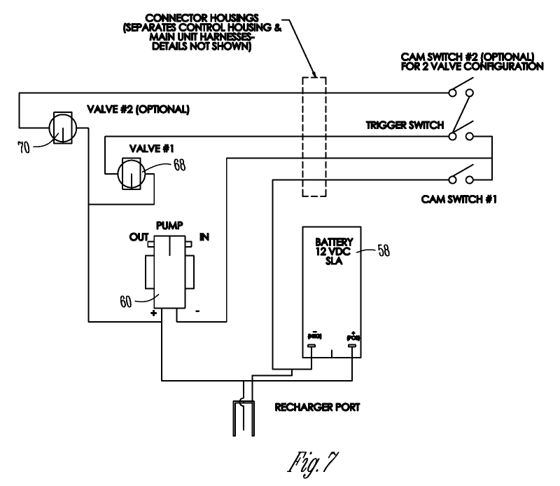

The electrical schematic for selective operation of pump 60, solenoids 68, 70 and valves for the nozzles 32, 34, 36 and 38 or hand wand 74 and user control housing 76 are shown in FIGS. 6 and 7. As can be seen, use of the control housing 76 through the appropriate electrical circuitry illustrated in FIG. 7 will selectively operate pump 60 to pump fluid via solenoid operated valves 68 and 70 to nozzles of booms 32, 34 and front fixed nozzles 36 and 38 respectively, or alternatively, by trigger controlled manual valve 78 sending fluid from tank 52 directly to wand 74.

Lever 80 is moveable from a closed position (FIG. 1) to an open position downwardly and forwardly which operates a boom control cable (not depicted) of conventional construction. It is a conventional flexible cable to selectively rotate boom 28 and 30 out into extended or operational position. This cable system allows the operator to selectively extend booms 28 and 30 to the fully extended position as shown in FIG. 2 or something less than that by simple adjustment of lever 80 to accommodate or adjust for varying width sidewalks. As a result, the spray pattern width can be controlled as the operation continues. As illustrated in FIG. 2, both spray booms 28, 30 are selectively extended by use of lever 80; spray booms 28, 30 are correspondingly retracted moving in and closed underneath the chassis via the pivot connection earlier explained upon backward movement of lever 80. Since the details of boom control via flexible cables to extend from extended or out position to in or retracted position are conventional, mechanical contrivances for adjustability well within the routine skill of the art, the specifics of those are not depicted herein. Hose 82 is connected to wand 74 to allow the wand 74 to be moved away from the unit 10 to selectively spray difficult to reach locations. Handle 84 is of conventional construction, is used for example on lawn mowers and may be collapsed via screw clamps 86, 88 for convenient storage.

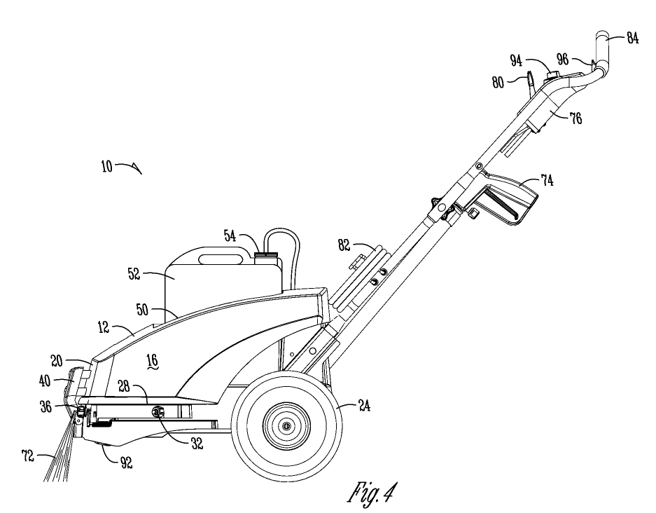

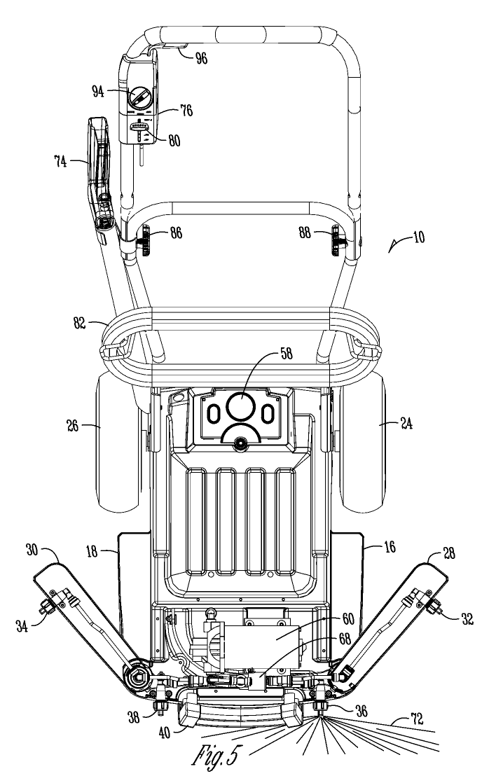

As best illustrated in FIG. 4, the chassis 14 has its associated set of chassis wheels 24, 26 conventionally mounted, but behind the center of gravity of tank 52 to provide a desired handle force for the operator. Stops 90 and 92 (see FIG. 5) extend down from the chassis towards the ground to help reduce the tendency of the unit to roll on an incline and provide wear-resistance and balance when moved by an operator when dragging unit by wand hose or other action.

Referring specifically to FIGS. 6 and 7, the following describes the preferred embodiment of the invention:

The user control housing provides the user with a rotary knob 94 and a rotary trigger 96 (lever 96, FIG. 1). The knob has internal cams that activate the switches shown in FIG. 7, and the knob 94 is provided with preferably 3 detent positions in its housing. For clarity, the detented positions may be referred to as OFF, 1, and 2.

When the knob 94 is in the off position, no electrical power flows to the pump 60, or to the two solenoid valves (#1 and #2 of FIG. 7) (solenoid 68, 70 operated) shown in FIG. 7. When the knob is rotated to position 1, cam switch #1 closes, which provides power from the battery 58 to the pump 60 and to the trigger switch. At this point the pump 60 pressurizes the plumbing system in preparation for spraying. If desired, while the rotary knob is in position #1, the manual valve of the spray wand, located within the pistol grip portion of the wand, can be activated by the operator to cause fluid flow to the wand nozzle only.

While the knob 94 is in position 1, the trigger can be activated, which closes the trigger switch, which in turn opens valve #1 which permits fluid to flow to the fixed nozzles 36, 38 only. In this embodiment, this allows the operator to spray a narrow pattern, without deicer waste, or application of excessive amounts of de-icer to the desired area.

When the rotary knob 94 is moved to position #2, cam switch #2 is closed. Under this condition, when the trigger is activated, and the trigger switch is closed, valves 1 and 2 are activated which causes fluid to flow to nozzles 38, 40, and 32 and 34.

An alternative embodiment is wherein all valves can be activated when the rotary knob is in position 1, thereby reducing the necessary knob positions to just OFF and 1. As such, valves 1 and 2 can then be replaced by a single valve of appropriate size, if desirable.

An additional alternate embodiment might entail moving cam switch #2 so that it is activated by the boom control lever. In such an arrangement, cam switch #2 would be activated only when the booms have been moved from the parked position. This would effectively prevent the boom nozzles from spraying while fully retracted, and would thereby allow the same functionality as the preferred embodiment by a different method.

In the preferred embodiment, the recharge port (FIG. 7) is designed so that when the plug from the recharging device is inserted into the recharger port, all of the electrical devices (pump, valves, and switches) are electrically isolated from the battery. This is to prevent damage to the recharger and/or any of the electrical devices on the unit. In addition, the isolation of the switches prevents inadvertent spraying should the operator activate the trigger during the recharging process.

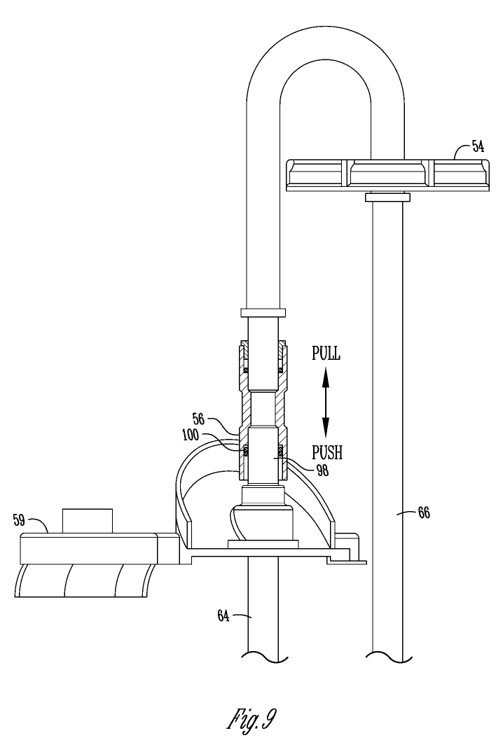

The details of the quick disconnect shown in FIG. 8 at 56, are shown in FIG. 9. The quick disconnect 56 can simply be pulled apart to disconnect the fluid hose of the detachable tank assembly from the battery cover 59, with its integral tube fitting 98. As can be seen in FIG. 9, there is a double O-ring for insertion—removal and release allowing a tool free and screw action free method of removing empty tank from system. Thus, should the user forget to disconnect the inlet assembly (FIG. 9) when the tank 52 is removed, it simply pulls the connection apart without damage.

In actual operation, the unit works in the following manner. Tank 52 is filled with liquid de-icer loaded into and connected to plumbing of unit 10. The unit is switched on, by rotary knob 94 on control housing 76, meaning battery 58 is electrically connected to allow pump 60 to be in operable position and the circuit of FIG. 6. Lever 80 is moved to the desired position so that spray boom arms 28 and 30 are extended such as illustrated in FIG. 2 and trigger 96 is closed by the operator to open appropriate valves via solenoids 68 and 70 to allow de-icer to be pumped to spray nozzles 32, 34, 36 and 38 as determined by position of 94 or other desired positions via pump 60. As a result, since the battery 58 energizes pump 60 when 94 is moved to 1 or 2 position, spray is delivered to by nozzles 32, 34, 36 and 38 in front of the unit 10 as determined by position of knob 94. If spraying is desired to be stopped, trigger 96 is released from its depressed state opening the circuit, closing valves (FIG. 7) via solenoid 68 and 70 and stopping the spray.

Similarly, if one desires to dispense spray via hand wand 74, wand valve 78 is manually opened to allow flow of spray from pump 60 out of wand 74 by way of hose 82. If the unit is desired for storage, lever 80 is pulled back and booms 28 and 30 retracted, handle 84 may be collapsed, tank 52 removed (if desired) and the unit stored.

Boom height and location relative to the ground surface have been selected to prevent spray drift from the nozzles 32, 34, 36 and 38 while still providing desired spray pattern and rate of application. In particular, they have been optimized for balance of pattern, rate, overspray and droplet size, impact, velocity, etc.

Worthy of note is the preferred molded plastic construction of the base and cover and boom mechanics, so that the device 10 will survive in a de-icer environment. There has been outlined in the specification, rather broadly, the more important features of the invention in order that its details may be better understood and appreciated for the present contribution to the art. It is to be understood, however, the invention is not limited in application to the precise details and construction arrangements here set forth, but that modifications can be made to provide other various combinations still achieving the objectives of the present invention. It is also to be realized that optimal dimensional relationships for the parts mentioned to function include variations in size, materials, shape, form, function, and that a variety of different physical components may be used for each of the separate individual elements here described.

With the above foregoing description of a preferred embodiment in mind and the description of the essential features set forth the invention is claimed as follows:

What is claimed is:

1. A liquid de-icer applicator, comprising:
a substantially horizontal frame chassis having a front end, a rear end, opposing sides and a mounted push handle;
a tank mounted on said chassis for holding and dispensing liquid de-icer;
a variably adjustable spray bar mounted to said chassis having at least one spray nozzle connected fluidly to said tank to define a spray system;
at least a pair of spaced apart wheels, mounted to said chassis; and
a power supply operatively connected to a pump for said spray system supported by said chassis; and
switches to selectively provide power to operate said pump for spraying de-icer.

2. The de-icer applicator of claim 1 wherein the variably adjustable spray bar can be adjusted to vary the spray pattern during operation.

3. The de-icer applicator of claim 1 wherein the front end includes at least one fixed position spray nozzle.

4. The applicator of claim 1 wherein the tank is a quick detach tank.

5. The applicator of claim 1 wherein the spray bars are movable from wing operating positions to wing retracted storage position by means of a lever operably connected to a flexible cable which rotates the spray bars from wing extended to wing retracted positions.

6. The applicator of claim 1 wherein the push handle is selectively collapsible.

7. The applicator of claim 1 wherein the spray system also includes a spray wand to selectively allow spray bar application of de-icer or wand application of de-icer.

8. The applicator of claim 1 wherein the foldable wing spray bars are moveable from a storage position of wing retracted to an extended wing use position or anywhere in between.

9. The spray applicator of claim 8 wherein the foldable wing system moves by operation of a flexible cable to allow extending and retraction of the wing spray bars to allow control of the spray pattern.

10. In a sprayer applicator for liquid de-icer application having a spray system, the improvement comprising:
a foldable wing spray bar mounted to the front of said applicator, which is fluidly connected to said spray system; and
a wand applicator to selectively allow wand application of de-icer or application from the spray bar.

11. The sprayer applicator of claim 10 which also includes an anti-skid plate mounted to said applicator to allow selective frictional engagement with the ground to act as a brake.

12. The sprayer applicator combination of claim 5 which includes a collapsible applicator handle.

13. The sprayer applicator of claim 5 which includes a control module to allow the operator to selectively spray from front mounted spray booms or from a wand sprayer.

14. The sprayer applicator combination of claim 5 which includes a pair of foldable wing spray bars.

15. The spray applicator of claim 10 which includes on the front of said applicator at least one fixed spray nozzle.

16. The sprayer applicator combination of claim 10 wherein the pair of foldable wings are spray bars pivotably mounted to the front portion of said applicator.

17. The sprayer applicator of claim 15 wherein the spray bars are movable from wing extended operating position to wing retracted storage position by means of a lever operably connected to a flexible cable which rotates the spray bars from wing extended to wing retracted positions or anywhere in between.

18. The sprayer applicator of claim 10 wherein the pump is a diaphragm pump.

19. The sprayer applicator of claim 1 wherein the pump is a diaphragm pump.
